(19) United States
(12) Patent Application Publication
(10) Pub. No.: US 2009/0092100 A1
(43) Pub. Date: Apr. 9, 2009

(54) METHOD FOR OPERATING FRAME IN MOBILE COMMUNICATION SYSTEM AND SYSTEM THEREOF

(75) Inventors: Mi-Hyun LEE, Seoul (KR); Ho-Kyu CHOI, Seongnam-si (KR); Jae-Weon CHO, Suwon-si (KR); Hyeon-Woo LEE, Suwon-si (KR); Ki-Chun CHO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/248,382

(22) Filed: Oct. 9, 2008

(30) Foreign Application Priority Data
Oct. 9, 2007 (KR) 2007-101435

(51) Int. Cl. H04W 36/30

(52) U.S. Cl. 370/332

(57) ABSTRACT

An apparatus and method for indicating a zone by a base station in a mobile communication system, in which a frame consists of an uplink sub-frame and a downlink sub-frame, and each of the uplink and downlink sub-frames includes a plurality of zones, are provided. The method includes identifying at least one of a channel condition of a mobile station, a condition on whether or not the mobile station supports inter-heterogeneous-network communication, a load condition of the base station, and a resource condition of a cell, determining if the mobile station can transmit/receive a signal through a number of zones that is less than the total number of zones based on the at least one identified condition and transmitting control information, which indicates a zone capable of being used for signal transmission/reception by the mobile station, to the mobile station, when the mobile station can transmit/receive the signal through the number of zones.

### PRIORITY

This application claims the benefit under 35 U.S.C. § 119(a) of a Korean patent application filed with the Korean Intellectual Property Office on Oct. 9, 2007 and assigned Serial No. 2007-101435, the entire disclosure of which is hereby incorporated by reference.

### BACKGROUND OF THE INVENTION

1. Field of the Invention

The present invention relates to a mobile communication system. More particularly, the present invention relates to an apparatus and method for configuring operating frames in a mobile communication system.

2. Description of the Related Art

Currently, mobile communication systems are evolving into the form of a system that can provide various services, such as broadcasting, multimedia images, multimedia messages, etc. Especially, 4^{th} generation mobile communication systems are being developed to support a data rate of 100 Mbps or higher for users moving at high speed, and to support a data rate of 1 Gbps or higher for users moving at low speed, beyond providing services mainly for voice and packet data communication.

Meanwhile, Multiple-Access schemes are taken into consideration in mobile communication systems in order to efficiently use limited frequency resources. Also, in the mobile communication systems, duplexing schemes distinguishing between two directions, that is, an uplink and a downlink, are taken into consideration. Schemes taking the multiple access and duplexing into consideration include a Time Division Duplexing (TDD) scheme and a Frequency Division Duplexing (FDD) scheme.

FIG. 1 is a view illustrating a structure of a conventional Time Division Duplexing Orthogonal Frequency Division Multiple Access (TDD-OFDMA) frame.

Referring to FIG. 1, the TDD-OFDMA frame includes a downlink sub-frame and an uplink sub-frame, which are spaced by a Transmission/reception Time Gap (TTG) and a Reception/transmission Time Gap (RTG). The downlink sub-frame includes a preamble zone, a control information zone, and a downlink data burst zone, and the uplink sub-frame includes an uplink data burst zone. The control information zone includes a Frame Control Header (FCH), a DownLink-Media Access Protocol (DL-MAP) and an UpLink-MAP (UL-MAP).

Meanwhile, in a mobile communication system, short latency is required for reliable high-speed data transmission. For example, in order to apply Hybrid Automatic Retransmission reQuest (HARQ) to a Voice over Internet Protocol (VoIP) service, short latency is required. However, it cannot be said that all packets require short latency.

Since there may be a packet requiring short latency, as described above, a frame supporting short latency is required to transmit such a packet at high speed. Also, in a system where packets not requiring short latency and packets requiring short latency are both used, a frame capable of efficiently transmitting the packets is required.

### SUMMARY OF THE INVENTION

An aspect of the present invention is to address at least the above-mentioned problems and/or disadvantages and to provide at least the advantages described below. Accordingly, an aspect of the present invention is to provide a system and method for efficiently transmitting/receiving packets requiring short latency in a mobile communication system.

Another aspect of the present invention is to provide a frame for transmitting/receiving the packets requiring short latency and provide a system and method for operating the frame.

In accordance with an aspect of the present invention, a method for indicating a zone by a base station in a mobile communication system, in which a frame consists of an uplink sub-frame and a downlink sub-frame, and each of the uplink and downlink sub-frames includes a plurality of zones, is provided. The method includes identifying at least one of a channel condition of a mobile station, a condition on whether or not the mobile station supports inter-heterogeneous-network communication, a load condition of the base station, and a resource condition of a cell, determining if the mobile station can transmit/receive a signal through a number of zones that is less than the total number of zones based on the at least one identified condition and transmitting control information, which indicates a zone capable of being used for signal transmission/reception by the mobile station, to the mobile station, when the mobile station can transmit/receive the signal through the number of zones.

In accordance with another aspect of the present invention, a method for receiving zone indication by a mobile station in a mobile communication system, in which a frame consists of an uplink sub-frame and a downlink sub-frame, and each of the uplink and downlink sub-frames includes a plurality of zones, is provided. The method includes informing a base station of a downlink channel condition, determining if control information, which indicates signal transmission/reception through a number of zones that is less than the total number of zones, is received from the base station informed of the downlink channel condition, transmitting/receiving a signal through the number of zones when the control information is received and operating in at least one of a sleep mode and an inter-heterogeneous-network communication mode in a remaining zone, which is not indicated in the control information.

In accordance with still another aspect of the present invention, a method for indicating a zone by a base station in a mobile communication system, in which a frame consists of an uplink sub-frame and a downlink sub-frame, and each of the uplink and downlink sub-frames includes a plurality of zones, is provided. The method includes identifying at least one of a channel condition of a mobile station, a load condition of the base station, and a resource condition of a cell, determining if it is necessary to increase, decrease or change zones currently activated for the mobile station based on the identified condition and transmitting control information, which indicates an increase, a decrease or a change of zones, to the mobile station, corresponding to the determination.

In accordance with still another aspect of the present invention, a method for receiving zone indication by a mobile station in a mobile communication system, in which a frame consists of an uplink sub-frame and a downlink sub-frame, and each of the uplink and downlink sub-frames includes a plurality of zones, is provided. The method includes determining if control information, which indicates at least one of an increase, a decrease and a change of zones to be used by the mobile station, is received from a base station, transmitting/receiving signals to/from the base station through the at least one of the increased, the decreased and the changed zones, corresponding to the control information indicating the at least one of the increase, the decrease and the change of zones and operating in at least one of a sleep mode and an inter-heterogeneous-network communication mode in a zone other than the zones used for signal transmission/reception.

In accordance with still another aspect of the present invention, a mobile communication system including a base station and a mobile station, wherein a frame consists of an uplink sub-frame and a downlink sub-frame, and each of the uplink and downlink sub-frames includes a plurality of zones, is provided. The system includes the base station for identifying at least one of a channel condition of the mobile station, a load condition of the base station, and a resource condition of a cell, for determining if the mobile station can transmit/receive a signal through a number of zones that is less than the total number of zones based on the identified condition, and for transmitting control information, which indicates a zone capable of being used for signal transmission/reception by the mobile station, to the mobile station, when the mobile station can transmit/receive the signal through the some zones and the mobile station for informing the base station of a downlink channel condition, for determining if control information, which indicates signal transmission/reception through the number of zones, is received from the base station taking the informed downlink channel condition into consideration, for transmitting/receiving a signal through the number of zones indicated by the control information when the control information is received, and for operating in at least one of a sleep mode or in an inter-heterogeneous-network communication mode in a remaining zone, which is not indicated in the control information.

In accordance with yet another aspect of the present invention, a mobile communication system including a base station and a mobile station, wherein a frame consists of an uplink sub-frame and a downlink sub-frame, and each of the uplink and downlink sub-frames includes a plurality of zones, is provided. The system includes the base station for identifying at least one of a channel condition of the mobile station, a load condition of the base station, and a resource condition of a cell, for determining if it is necessary to increase, decrease or change zones to be used by the mobile station based on the identified condition, and for transmitting control information, which indicates an increase, a decrease or a change of zones, to the mobile station, when it is determined to be necessary to increase, decrease, or change zones to be used by the mobile station, respectively and the mobile station for determining if control information, which indicates the increase, the decrease or the change of zones to be used by the mobile station, is received from the base station, and for transmitting/receiving signals through the corresponding increased, decreased or changed zones, when the control information respectively indicating the increase, the decrease or the change of zones is received.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating a structure of a conventional TDD-OFDMA frame;

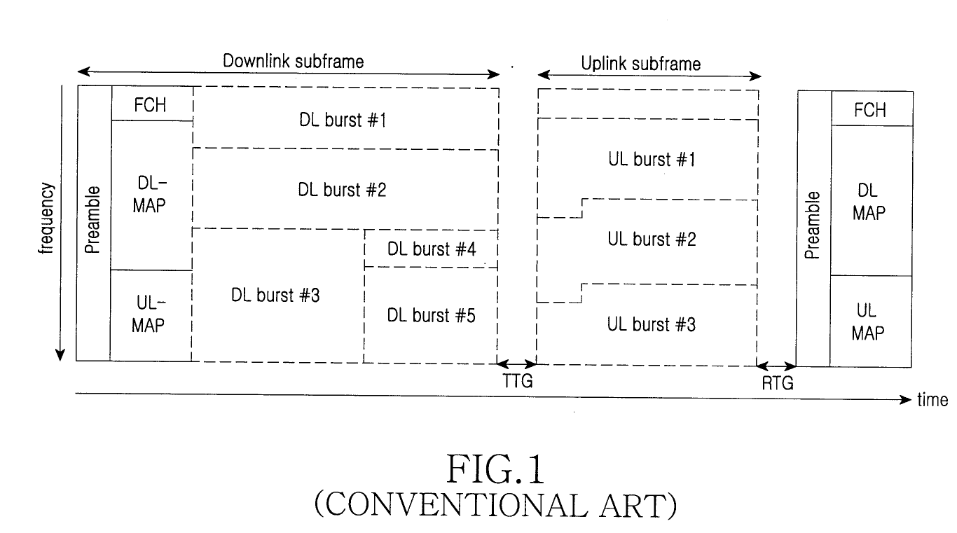

FIG. 2 is a view illustrating a structure of a frame including short latency zones according to an exemplary embodiment of the present invention;

FIG. 3 is a flowchart illustrating a procedure of transmitting control information from a base station to a mobile station according to an exemplary embodiment of the present invention;

FIG. 4 is a flowchart illustrating a procedure of processing signals according to whether or not a mobile station receives control information according to an exemplary embodiment of the present invention;

FIG. 5 is a view illustrating a structure of a frame for signal transmission/reception of mobile stations which perform communication through some zones according to an exemplary embodiment of the present invention;

FIG. 6 is a flowchart illustrating an operation procedure of a base station when activated zones increase/decrease in number or are changed according to an exemplary embodiment of the present invention; and

FIG. 7 is a flowchart illustrating an operation procedure of a mobile station when the mobile station receives a zone increase/decrease or change indication according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention propose a new frame structure for supporting transmission/reception of a signal requiring short latency and provide an apparatus and method for efficiently operating the proposed frame according to the status of a Mobile Station (MS) in a mobile communication system.

A frame structure newly proposed according to exemplary embodiments of the present invention has a format in which an uplink sub-frame and/or a downlink sub-frame consists of a plurality of zones. Here, the frame may be a Time Division Duplexing Orthogonal Frequency Division Multiple Access (TDD-OFDMA) frame. Each zone in the downlink sub-frame has a corresponding zone in the uplink sub-frame, and includes resource allocation information, feedback information, and relevant control information. That is, each zone corresponds to a transfer zone which enables a signal requiring short latency to be transmitted/received, and may be defined as follows.
Short Latency Zone (SLZ): When data is transmitted through the SLZ, the data can satisfy a short latency requirement. The SLZ exists in an uplink and a downlink, respectively. The SLZ is first used for data requiring short latency, and may then be used for data other than the data requiring short latency in view of resource utilization.

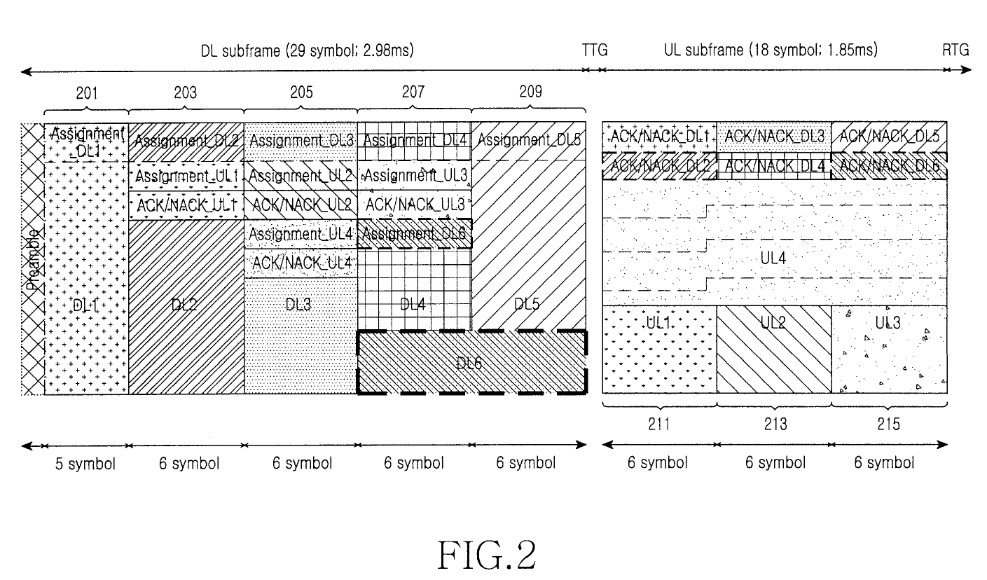

FIG. 2 is a view illustrating a structure of a frame including short latency zones according to an exemplary embodiment of the present invention.

Referring to FIG. 2, the frame includes a downlink sub-frame and an uplink sub-frame, wherein a ratio between the number of symbols of the downlink sub-frame and the number of symbols of the uplink sub-frame may be, for example, 29:18. The downlink sub-frame includes five zones 201, 203, 205, 207, and 209, and the uplink sub-frame includes three zones 211, 213, and 215.

In each downlink zone, Assignment DLx or Assignment ULx represents a region which includes control information, such as a packet format, and data burst assignment information of a DLx region or ULx region, to which a data burst is assigned. That is, a mobile station acquires control information included in each zone within a downlink sub-frame, and then decodes a data burst assigned to the mobile station. The mobile station consumes power in order to acquire control information included in each zone. However, there may be a zone which does not include a data burst assigned to the mobile station. In this case, the mobile station acquiring control information included in all zones unnecessarily consumes power.

To address such a problem, a method for reducing power consumption through efficient scheduling for mobile stations by taking the newly proposed frame structure, the status of a mobile station, the status of a base station, the status of a cell, etc. into consideration will now be described.

A base station schedules a target mobile station to acquire control information from all zones or to acquire control information only from specified zones by taking the status of the mobile station, whether or not inter-heterogeneous-network communication is supported, the status of the base station, the status of a cell, etc into consideration. Here, the status may be one of a cell loading situation, the capability of the mobile station, a service type, a data rate, a geographical location of the mobile station, etc.

For example, in order for a mobile station that requires high-speed service to transmit/receive a large amount of data, the mobile station must be assigned with more than a reference amount of resources. Accordingly, the mobile station must use more than a reference number of zones in order to transmit/receive signals to/from the base station. Similarly, when a mobile station is located in a cell boundary and the channel condition of the mobile station is worse than a reference channel condition, a situation may arise in which the mobile station must transmit/receive signals through a number of zones that is greater than a reference number of zones.

In contrast, in order for a mobile station requiring a low-speed service provision to transmit/receive less than a reference amount of data, the mobile station can transmit/receive signals using fewer than the reference number of zones. Furthermore, when a mobile station is located in the center of a cell and the channel condition of the mobile station is better than the reference channel condition, a situation in which the mobile station can transmit/receive signals using fewer than the reference number of zones, and not through all zones, may occur. Also, a mobile station may transmit/receive signals through a given number of zones in a certain period in order to transmit/receive a constant amount of data. Therefore, the base station can adaptively activate zones to be provided to each mobile station according to various situations. Here, the term “some zones” represents one or more zones, the number of which is lower than the number of total zones.

A mobile station may communicate with heterogeneous communication systems in a time period other than the activated zones. That is, when the mobile station supports communication with different communication systems (CLC: Co-Located Co-existence), the mobile station can communicate with heterogeneous communication systems, such as WiFi and Bluetooth.

Activation of zone communication, as described above, may be achieved through a preliminary negotiation between the base station and mobile station. Also, as described above, the base station may adaptively provide control information relating to an activated zone to the mobile station according to communication situations, and the mobile station may transmit/receive signals through the activated zone according to received control information.

As described above, according to exemplary embodiments of the present invention, the mobile station negotiates with the base station about whether or not a zone is to be activated, acquires control information, recognizes a zone activated for the mobile station, and can transmit/receive signals through the activated zone from signal transmission/reception in a next frame. Meanwhile, the base station may indicate information on an activated zone by transmitting a message to the mobile station instead of inserting control information according to each zone.

The following description will be given of a method for performing communication by inserting the control information into each zone.

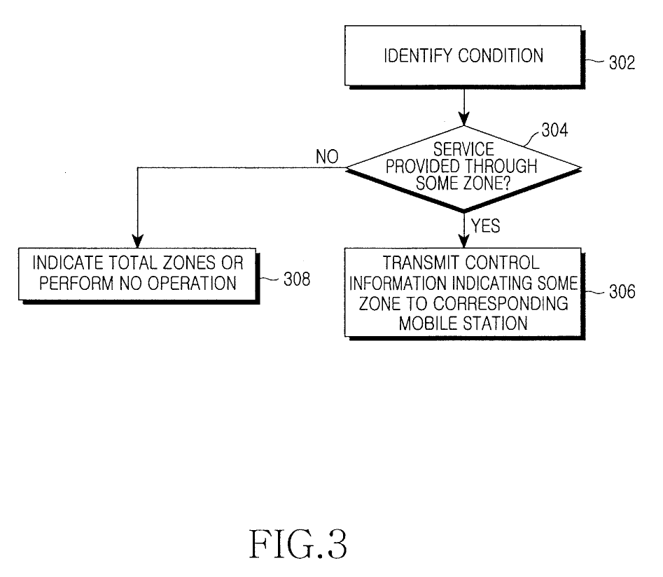

FIG. 3 is a flowchart illustrating a procedure of transmitting control information from a base station to a mobile station according to an exemplary embodiment of the present invention. Here, it is assumed that some zones have been activated through a preliminary negotiation between the base station and the mobile station.

Referring to FIG. 3, for the mobile station, for which some zones have been activated, the base station identifies the status of the mobile station, the status of the base station, the status of a cell, etc. in step 302. Here, the status of the mobile station can be identified through information fed back to the base station from the mobile station, or through headroom information or the like received by the base station. The status of the base station may be a load condition, and the status of the cell may be a resource usage condition. That is, the base station may determine if the target mobile station is in a state in which it can receive a service using only some zones. For example, the base station may determine if the target mobile station is in a state in which the channel condition of the mobile station is better than a reference channel condition, if the loading factor of the base station is lower than a reference loading factor, if the resource usage rate of cell is lower than a reference resource usage rate and the like.

In step 304 it is determined if the mobile station can receive a service through some zones instead of all the zones. When it is determined in step 304 that the mobile station can receive a service through some zones, instead of all the zones, or that the base station can provide the service through some zones, the base station transmits control information for reporting the some zones, through which the mobile station can transmit/receive uplink and downlink signals, to the mobile station in step 306. Then, the mobile station activates a zone according to received control information and transmits/receives signals through the activated zone. The mobile station continuously transmits/receives signals only through the activated zones until the activated zone is changed. Here, the activated zone may be activated or changed at every frame or at certain frame periods. In contrast, when it is determined in step 304 that the service cannot be provided through some zones, the base station may notify the mobile station of activation of all zones, or may suggestively activate all zones without any notification in step 308.

That is, after identifying if some zones can be activated through a preliminary negotiation with the base station, the mobile station receives control information of each zone, and determines if each zone is activated. Thereafter, the mobile station transmits/receives signals only through the some zones that are activated.

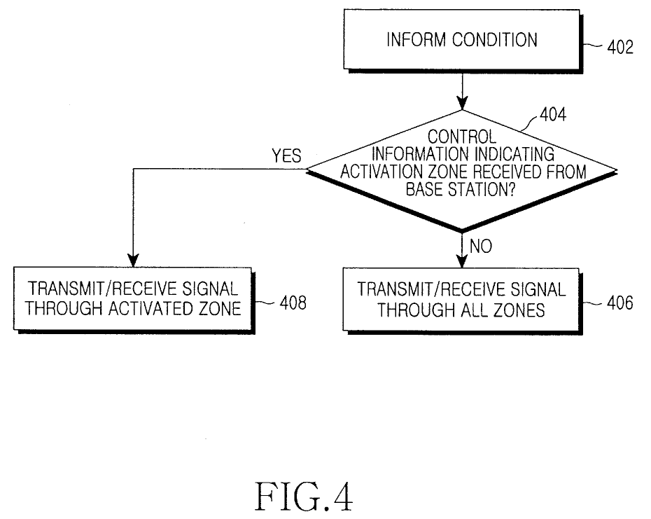

FIG. 4 is a flowchart illustrating a procedure of processing signals according to whether or not a mobile station receives control information according to an exemplary embodiment of the present invention.

Referring to FIG. 4, the mobile station informs the base station of whether or not the mobile station can perform communication through some zones, the capability of the mobile station, a type of desired service, etc. in step 402. In step 404, the mobile station receives control information according to each zone with respect to all zones. When the control information does not include information on an activated zone, or when the control information indicates that all zones are activated, the mobile station transmits/receives signals through the total zones in step 406. In contrast, when the control information indicates that signals should be transmitted/received through an activated zone, the mobile station transmits/receives signals through the activated zone, which is indicated by the control information, in step 408. Also in step 408, the mobile station operates in a sleep mode or inter-heterogeneous-network communication mode in the remaining zones which are not indicated.

As described above, when the mobile station transmits/receives signals only through some zones, the mobile station need not receive or decode signals in zones other than the some zones, so that it is possible to reduce power consumption. Moreover, since the mobile station operates in a sleep mode in zones other than the some zones, it is possible to reduce power consumption and therefore operate more efficiently. Meanwhile, if necessary for channel estimation and report, the mobile station may receive a signal in an inactivated zone and perform a channel estimation. In this case, the mobile station does not decode data received in the inactivated zone.

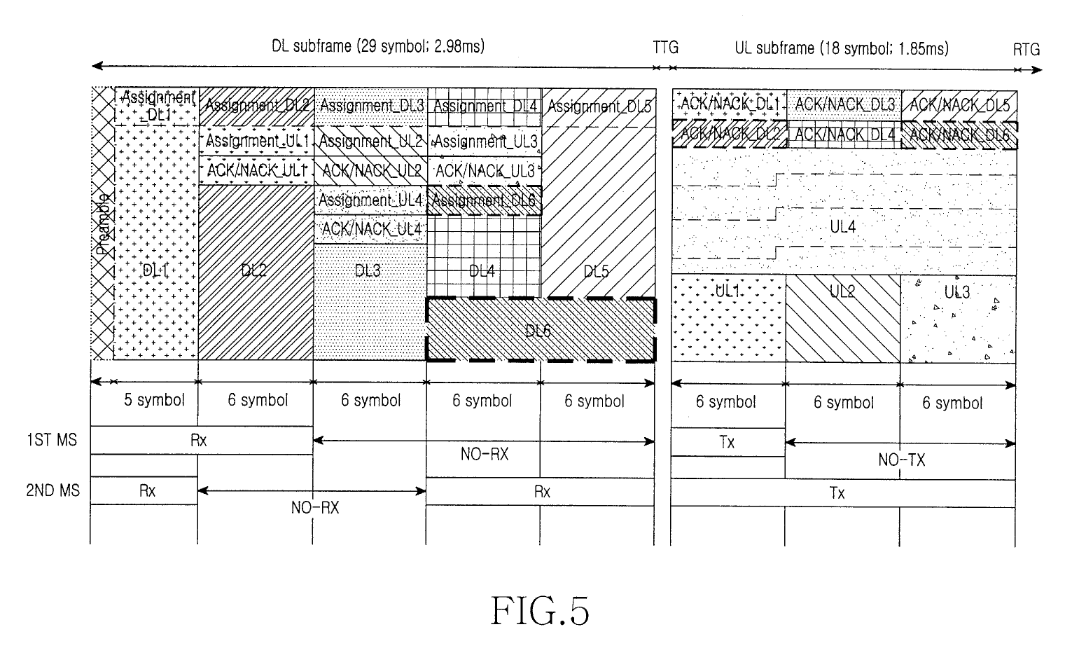

FIG. 5 is a view illustrating a structure of a frame for signal transmission/reception of mobile stations which perform communication through some zones according to an exemplary embodiment of the present invention.

Referring to FIG. 5, a first mobile station (1^{st} MS) receives downlink signals through DL1 and DL2 regions of first and second zones in a downlink sub-frame. Furthermore, the 1^{st} MS operates in a sleep mode, in which the mobile station does not receive a signal, in the remaining zones (i.e. third to fifth zones) of the downlink sub-frame. In addition, the 1^{st} MS transmits an uplink signal through a UL1 region of a first zone in an uplink sub-frame, and operates in a sleep mode in the remaining zones (i.e. second and third zones) of the uplink sub-frame.

A second mobile station (2^{nd} MS) receives downlink signals through DL1 and DL6 regions of first, fourth, and fifth zones in the downlink sub-frame. Furthermore, the 2^{nd} MS operates in a sleep mode in the remaining zones (i.e. second and third zones) of the downlink sub-frame. In addition, the 2^{nd} MS transmits uplink signals through all zones of the uplink sub-frame.

The first mobile station may be a mobile station which is in a good channel condition and can transmit/receive signals through some zones, that is, fewer zones than a reference number of zones. In contrast, the second mobile station may be in a poor channel condition and must transmit/receive signals through more zones, as compared with the first mobile station. The zones used by the first and second mobile stations may be changed at every frame or at certain frame periods. Therefore, each mobile station maintains activated zones at every frame or at certain frame periods until information on activated zones is changed.

Meanwhile, the base station may adaptively operate zones by taking the loading condition of the cell into consideration. For example, with respect to a downlink sub-frame constituted by five zones, a base station, the loading factor of which is low, may activate only some zones and transmit signals, instead of transmitting signals using all zones.

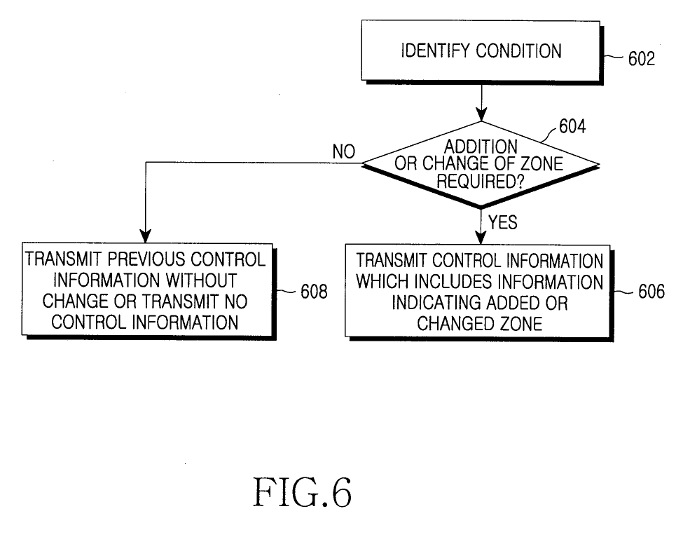

FIG. 6 is a flowchart illustrating an operation procedure of a base station when activated zones increase/decrease in number or are changed according to an exemplary embodiment of the present invention.

Referring to FIG. 6, the base station identifies the status of the base station, the status of a mobile station, the status of a cell, etc. in step 602. In step 604, the base station determines if it is necessary to add or change a zone to be used by the mobile station by taking one or more of the identified various statuses into consideration. For example, the base station may determine to add one or more zones when the channel condition of the mobile station is worse than a reference channel condition, and may determine to reduce the number of zones when the channel condition of the mobile station is better than the reference channel condition. Also, the base station may change zones to be used by the mobile station by taking various factors into consideration. That is, the base station may instruct the mobile station, which currently uses a first zone, to change zones and use a second zone.

When it is necessary to change zones or to increase/decrease the number of zones as a result of the determination, the base station transmits control information, corresponding to zone increase/decrease or change indication information, to the mobile station in step 606. In contrast, when it is unnecessary to change or to increase/decrease zones in number, the base station transmits the control information of a previous frame without change, or does not transmit any control information in step 608. The base station may provide the zone indication information not only in the form of a broadcast as described above, but also in various forms as described below.

First, the base station may provide indication information on all zones to be increased/decreased or changed, through a specific zone among zones currently activated for a corresponding mobile station. The zone indication information includes information on the number and locations of zones to be activated from the current frame or the next frame. The first method may be used when many zones are to be increased/decreased or changed.

Second, there is a method of activating one zone through another zone. For example, when the base station intends to activate two zones, i.e. second and third zones, in a state in which a first zone has been activated, the base station may provide zone indication information for activating the second zone through the first zone, and provide zone indication information for activating the third zone through the second zone. Since the second method requires information on only the location of a zone to be activated, but does not require information on the number of zones to be activated, the amount of resources necessary for zone indication is reduced as compared with the first method.

Third, the base station may activate all zones following the current zone, or all zones in the current frame. The third method is used when the base station instructs a mobile station, which uses some zones, to use all zones. For example, the base station transmits control information including 1-bit indicator information, that is, control information that indicates all-zone communication, to a mobile station, so that the mobile station can change into the all-zone communication. After changing into the all-zone communication according to an all-zone communication instruction, the mobile station may again change into partial-zone communication by taking control information of each zone into consideration.

Fourth, the base station may inform of a zone increase/decrease or change by means of a bitmap. For example, when one frame consists of eight zones, the base station may use an 8-bit bitmap in order to inform a mobile station of which zone is activated. For example, when only a second zone is activated, the base station may transmit zone indication information including “01000000” to a corresponding mobile station.

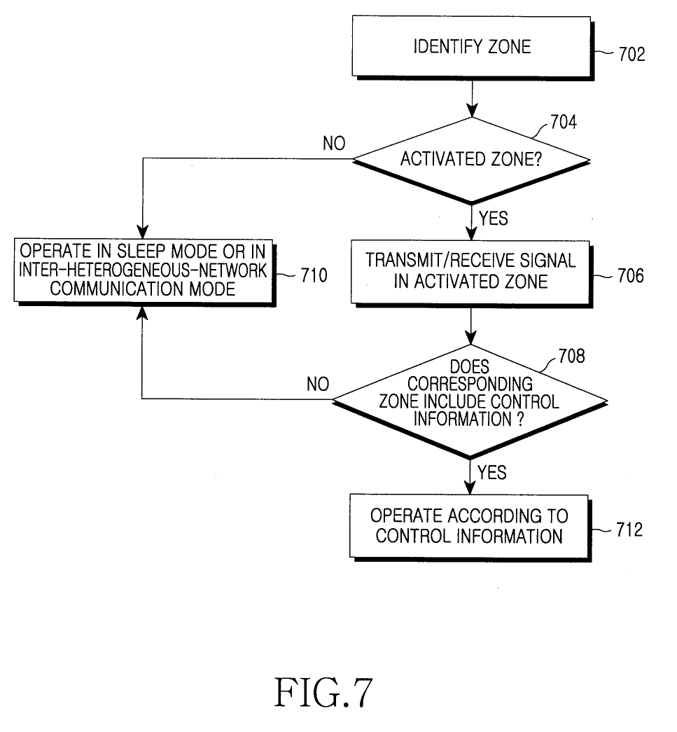

FIG. 7 is a flowchart illustrating an operation procedure of a mobile station when the mobile station receives a zone increase/decrease or change indication according to an exemplary embodiment of the present invention.

Referring to FIG. 7, the mobile station identifies the current zone in step 702. In step 704, the mobile station determines if the current zone corresponds to an activated zone. When it is determined that the current zone corresponds to an activated zone, the mobile station transmits/receives signals in the activated zone in step 706. In step 708, the mobile station determines if a corresponding zone includes control information indicating increase/decrease or change of activated zones. When the corresponding zone includes control information indicating an increase/decrease or change of zones as a result of the determination, the mobile station recognizes the increased/decreased or changed zones to be activated in step 712.

Meanwhile, when it is determined in step 704 that a corresponding zone does not correspond to an activated zone, the mobile station operates in a sleep mode in the corresponding zone in step 710. Also, when it is determined in step 708 that a corresponding zone does not include control information, the mobile station operates in the sleep mode in the corresponding zone in step 710.

The signal transmission/reception method according to the present invention can be applied to a base station. In detail, the base station may transmit a downlink signal to a mobile station through one specified zone by taking the load condition of the base station into consideration. For example, when the load conditions of second and third zones are better than those of the other zones, or are better than that of a reference load condition, in a downlink sub-frame constituted by five zones, the base station may transmit signals to the mobile station only through the second and third zones. It goes without saying that, before receiving the signals through the second and third zones from the base station, the mobile station must have recognized that the signals are to be transmitted through the second and third zones. This can be achieved through a preliminary negotiation between the base station and the mobile station.

Similarly, the base station may inform the mobile station of a specified zone within an uplink sub-frame so that the mobile station can transmit an uplink signal to the base station only in the specified zone.

Exemplary embodiments of the present invention propose a new frame structure in a mobile communication system, and provide a system and method for efficiently operating the proposed frame structure, so that it is possible to transmit packets requiring short latency. In addition, a mobile station transmits signals through some zones, and operates in a sleep mode in the remaining zones, so that it is possible to reduce power consumption and thereby increase efficiency.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for indicating a zone by a base station in a mobile communication system, in which a frame consists of an uplink sub-frame and a downlink sub-frame, and each of the uplink and downlink sub-frames includes a plurality of zones, the method comprising:
identifying at least one of a channel condition of a mobile station, a condition of whether the mobile station supports inter-heterogeneous-network communication, a load condition of the base station, and a resource condition of a cell;
determining if the mobile station can transmit/receive a signal through a number of zones that is less than the total number of zones based on the at least one identified condition; and
transmitting control information, which indicates a zone capable of being used for signal transmission/reception by the mobile station, to the mobile station, when the mobile station can transmit/receive the signal through the number of zones.

2. The method as claimed in claim 1, wherein the determining if the mobile station can transmit/receive the signal through the number of zones comprises, when at least one of the channel condition of the mobile station is better than a reference channel condition, the loading factor of the base station is lower than a reference loading factor and a resource usage rate of the cell is lower than a reference resource usage rate, determining that the mobile station can transmit/receive a signal through the number of zones.

3. The method as claimed in claim 1, wherein the control information comprises the number and location information of zones which the mobile station can use for signal transmission/reception.

4. The method as claimed in claim 1, wherein the transmitting of the control information comprises transmitting using resources of a zone pre-activated for the mobile station.

5. A method for receiving zone indication by a mobile station in a mobile communication system, in which a frame consists of an uplink sub-frame and a downlink sub-frame, and each of the uplink and downlink sub-frames includes a plurality of zones, the method comprising:
informing a base station of a downlink channel condition;
determining if control information, which indicates signal transmission/reception through a number of zones that is less than the total number of zones, is received from the base station informed of the downlink channel condition;
transmitting/receiving a signal through the number of zones when the control information is received; and
operating in at least one of a sleep mode and an inter-heterogeneous-network communication mode in a remaining zone, which is not indicated in the control information.

6. The method as claimed in claim 5, wherein the control information comprises the quantity and location information of the number of zones.

7. The method as claimed in claim 5, wherein the control information is received through a zone currently activated for the mobile station.

8. A method for indicating a zone by a base station in a mobile communication system, in which a frame consists of an uplink sub-frame and a downlink sub-frame, and each of the uplink and downlink sub-frames includes a plurality of zones, the method comprising:
identifying at least one of a channel condition of a mobile station, a load condition of the base station, and a resource condition of a cell;
determining if it is necessary to increase, decrease or change zones currently activated for the mobile station based on the identified condition; and
transmitting control information, which indicates an increase, a decrease or a change of zones, to the mobile station, corresponding to the determination.

9. The method as claimed in claim 8, wherein the determining of whether it is necessary to increase, decrease or change zones currently activated for the mobile station comprises determining that it is necessary to increase the number of zones when the channel condition of the mobile station is worse than a reference channel condition, and determining that it is necessary to decrease the number of zones when the channel condition of the mobile station is better than the reference channel condition.

10. The method as claimed in claim 8, wherein the control information comprises the quantity and location information of zones which result from the increase, the decrease or the change of zones.

11. A method for receiving zone indication by a mobile station in a mobile communication system, in which a frame consists of an uplink sub-frame and a downlink sub-frame, and each of the uplink and downlink sub-frames includes a plurality of zones, the method comprising:
determining if control information, which indicates an increase, a decrease or a change of zones to be used by the mobile station, is received from a base station;
transmitting/receiving signals to/from the base station through increased, decreased or changed zones, corresponding to the control information indicating the increase, the decrease or the change of zones; and
operating in at least one of a sleep mode and an inter-heterogeneous-network communication mode in a zone other than the zones used for the signal transmission or reception.

12. The method as claimed in claim 11, wherein the control information comprises the quantity and location information of zones which result from the increase, the decrease or the change of zones.

13. A mobile communication system including a base station and a mobile station, wherein a frame consists of an uplink sub-frame and a downlink sub-frame, and each of the uplink and downlink sub-frames includes a plurality of zones, the system comprising:
the base station for identifying at least one of a channel condition of the mobile station, a load condition of the base station, and a resource condition of a cell, for determining if the mobile station can transmit/receive a signal through a number of zones that is less than the total number of zones based on the identified condition, and for transmitting control information, which indicates a zone capable of being used for signal transmission/reception by the mobile station, to the mobile station, when the mobile station can transmit/receive the signal through the number of zones; and
the mobile station for informing the base station of a downlink channel condition, for determining if control information, which indicates signal transmission/reception through the number of zones, is received from the base station taking the informed downlink channel condition into consideration, for transmitting/receiving a signal through the number of zones indicated by the control information when the control information is received, and for operating in at least one of a sleep mode and an inter-heterogeneous-network communication mode in a remaining zone, which is not indicated in the control information.

14. The system as claimed in claim 13, wherein, when at least one of the channel condition of the mobile station is better than a reference channel condition, the loading factor of the base station is lower than a reference loading factor, and a resource usage rate of the cell is lower than a reference resource usage rate, the base station determines that the mobile station can transmit/receive a signal through the number of zones.

15. The system as claimed in claim 13, wherein the control information comprises the quantity and location information of zones which the mobile station can use for signal transmission/reception.

16. The system as claimed in claim 13, wherein the base station transmits the control information using resources of a zone pre-activated for the mobile station.

17. A mobile communication system including a base station and a mobile station, wherein a frame consists of an uplink sub-frame and a downlink sub-frame, and each of the uplink and downlink sub-frames includes a plurality of zones, the system comprising:
the base station for identifying at least one of a channel condition of the mobile station, a load condition of the base station, and a resource condition of a cell, for determining if it is necessary to increase, decrease or change zones to be used by the mobile station based on the identified condition, and for transmitting control information, which indicates an increase, a decrease or a change in zones, to the mobile station, when it is determined to be necessary to increase, decrease or change zones to be used by the mobile station, respectively; and
the mobile station for determining if control information, which indicates the increase, the decrease or the change of zones to be used by the mobile station, is received from the base station, and for transmitting/receiving signals through the corresponding increased, decreased or changed zones, when the control information respectively indicating the increase, the decrease or the change of zones is received.

18. The system as claimed in claim 17, wherein the base station determines to increase the number of zones to be used by the mobile station when the channel condition of the mobile station is worse than a reference channel condition, and determines to reduce the number of zones to be used by the mobile station when the channel condition of the mobile station is better than the reference channel condition.

19. The system as claimed in claim 17, wherein the control information comprises the quantity and location information of zones which result from the increase, the decrease or the change of zones.
